(19) United States
(12) Patent Application Publication
(10) Pub. No.: US 2025/0298174 A1
(43) Pub. Date: Sep. 25, 2025

(54) LIGHT TRANSMISSION WINDOW MEMBER, MANUFACTURING METHOD THEREFOR, PRISM, AND ELECTRONIC EQUIPMENT

(71) Applicant: NIPPON ELECTRIC GLASS CO., LTD., Otsu-shi, Shiga (JP)

(72) Inventors: Yoshimasa YAMAGUCHI, Otsu-shi (JP); Hiroki FUJITA, Otsu-shi (JP); Takeshi INUI, Otsu-shi (JP)

(21) Appl. No.: 18/859,265

(22) PCT Filed: Jun. 1, 2023
(86) PCT No.: PCT/JP2023/020518

§ 371 Date: Oct. 23, 2024

(30) Foreign Application Priority Data
Jun. 7, 2022 (JP) 2022-092305

(51) Int. Cl. G02B 5/04; G02B 1/11; G04G 17/08

(52) U.S. Cl. CPC G02B 5/04; G02B 1/11; G04G 17/08

(57) ABSTRACT

Provided is a light transmission window member that, when used in an electronic device, such as a wearable device, can provide an excellent feeling of use and aesthetic quality and can make it less likely that a light intensity loss occurs. A light transmission window member 1 includes: a plate-shaped substrate 2 including a light transmission portion 5; and a metalized film 3 provided on at least a portion of a side surface 2c of the substrate 2, wherein a solder blocking portion 4 is provided on at least a portion of the side surface 2c of the substrate 2.

### TECHNICAL FIELD

The present invention relates to light transmission window members including a light transmission portion, methods for manufacturing the same, prisms, and electronic devices in which the light transmission window member or the prism is used.

### BACKGROUND ART

In electronic devices in which an optical element, such as an optical semiconductor, is used, their housings may be provided with openings for light transmission. A light transmission window member is mounted to the opening in such a housing for the purpose of ensuring the hermeticity in the interior of the housing or other purposes.

For example, Patent Literature 1 below discloses an optical member including: a substrate including a light transmission portion; an antireflection layer provided on a portion of a principal surface of the substrate other than the peripheral portion thereof; and a metallic layer having a frame-like shape along the peripheral portion of the antireflection layer in plan view of the substrate. In Patent Literature 1, the opening in the housing is sealed by mounting the optical member to the opening in the housing. Furthermore, in mounting the optical member to the opening in the housing, the metallic layer provided on the optical member is bonded through a bonding material, such as solder, to the housing.

### CITATION LIST

### Patent Literature

[PTL 1]
JP-A-2019-201173

### SUMMARY OF INVENTION

### Technical Problem

A wearable device, such as a smartwatch, may be used with a light transmission window member disposed on the wrist (the skin) side of the wearable device. More specifically, the wearable device may be used with an opening in its housing disposed on the wrist (the skin) side and a light transmission window member fitted in the opening. If in this case it is sought to surely seal the opening with solder, the solder will protrude from the opening and, therefore, it is difficult to dispose the housing and the light transmission window member in the same plane along the surface of the wearable device nearest the wrist (the skin). For this reason, a substrate of the light transmission window member is disposed slightly above the surface of the wearable device nearest the wrist (the skin), which may form a level difference (a recess). If such a recess is formed, this may cause a sense of discomfort for such reasons as retention of sweat into the recess during wearing of the device or may cause a loss of light intensity to be measured. Furthermore, the aesthetic quality of the wearable device as viewed from the wrist (the skin) side may be impaired. In addition, metal allergy may be caused by the solder being a metallic material.

An object of the present invention is to provide: a light transmission window member that, when used in an electronic device, such as a wearable device, can provide an excellent feeling of use and aesthetic quality and can make it less likely that a light intensity loss occurs; a method for manufacturing the light transmission window member; a prism; and an electronic device.

### Solution to Problem

A description will be given below of aspects of a light transmission window member, a method for manufacturing the light transmission window member, a prism, and an electronic device, all of which can solve the above problems.

A light transmission window member of aspect 1 in the present invention includes: a plate-shaped substrate including a light transmission portion; and a metalized film provided on at least a portion of a side surface of the substrate, wherein a solder blocking portion is provided on at least a portion of the side surface of the substrate.

A light transmission window member of aspect 2 is the light transmission window member according to aspect 1, wherein the substrate may include: a first principal surface provided on a light entrance side of the substrate; a second principal surface opposed to the first principal surface and provided on a light exit side of the substrate, the side surface may connect the first principal surface and the second principal surface, and the metalized film may also be provided on the first principal surface.

A light transmission window member of aspect 3 is the light transmission window member according to aspect 2, wherein the metalized film may also be provided on a corner portion connecting the first principal surface and the side surface of the substrate.

A light transmission window member of aspect 4 is the light transmission window member according to aspect 2 or 3, wherein a ratio of a thickness of the metalized film on the side surface to a thickness of the metalized film on the first principal surface ((thickness on side surface)/(thickness on first principal surface)) may be not less than 0.05 and not more than 1.00.

A light transmission window member of aspect 5 is the light transmission window member according to any one of aspects 2 to 4, wherein when a direction connecting the first principal surface and the second principal surface is a thickness direction, the solder blocking portion may be provided on the side surface of the substrate to extend in the thickness direction from the second principal surface.

A light transmission window member of aspect 6 is the light transmission window member according to aspect 5, wherein the solder blocking portion may be provided on a portion of the side surface constituting not less than 5% and less than 100% of an entire thickness of the side surface and extending in the thickness direction from the second principal surface.

A light transmission window member of aspect 7 is the light transmission window member according to any one of aspects 1 to 6, wherein the solder blocking portion may be constituted by a portion which is other than where the metalized film is provided and in which the substrate is exposed.

A light transmission window member of aspect 8 is the light transmission window member according to any one of aspects 1 to 7, wherein the solder blocking portion may be constituted by an inorganic film being provided in a surface layer of the light transmission window member, the inorganic film having a low wettability for the solder.

A light transmission window member of aspect 9 is the light transmission window member according to aspect 8, wherein the inorganic film may be an oxide film, a nitride film, a fluoride film or a sulfide film.

A light transmission window member of aspect 10 is the light transmission window member according to any one of aspects 1 to 9, wherein the metalized film may include: an adhesion layer that contacts the substrate and contains at least one of Cr and Ti; an anti-diffusion layer that is provided on the adhesion layer and contains at least one selected from the group consisting of Ni, Pt, and Pd; and a solder bonding layer that is provided on the anti-diffusion layer and contains at least one of Au and Pt.

A light transmission window member of aspect 11 is the light transmission window member according to any one of aspects 1 to 10, wherein solder may be provided on the metalized film and the solder may contain at least one selected from the group consisting of Au, Sn, and In.

A light transmission window member of aspect 12 is the light transmission window member according to aspect 11, wherein the solder may be in a ring preform or in paste form.

A light transmission window member of aspect 13 is the light transmission window member according to any one of aspects 1 to 12, wherein a shape in plan of the substrate may be approximately circular of approximately rectangular.

A light transmission window member of aspect 14 of the present invention includes: a plate-shaped substrate including a light transmission portion; and a metalized film provided on at least a portion of a side surface of the substrate and having a high wettability for solder, wherein a solder blocking portion having a low wettability for solder is provided on at least a portion of the side surface of the substrate.

A method for manufacturing a light transmission window member of aspect 15 in the present invention includes the steps of: preparing a plate-shaped substrate including a light transmission portion; and depositing a metalized film on at least a portion of a side surface of the substrate, wherein depositing the metalized film is performed to provide a solder blocking portion on at least a portion of the side surface of the substrate.

A method for manufacturing a light transmission window member of aspect 16 is the method for manufacturing a light transmission window member according to aspect 15, wherein the metalized film may be deposited by a vacuum evaporation method or a sputtering method to spread from a portion of a principal surface of the substrate located on a light entrance side of the substrate to the portion of the side surface.

A method for manufacturing a light transmission window member of aspect 17 in the present invention includes the steps of: preparing a plate-shaped substrate including a light transmission portion; and depositing a metalized film having a high wettability for solder on at least a portion of a side surface of the substrate, wherein depositing the metalized film is performed to provide a solder blocking portion having a low wettability for solder on at least a portion of the side surface of the substrate.

A prism of aspect 18 in the present invention includes: a prism-shaped substrate that has a bottom surface and a side surface connected to the bottom surface and includes a light transmission portion; and a metalized film provided on at least a portion of the side surface of the substrate, wherein a solder blocking portion is provided on at least a portion of the side surface of the substrate.

A prism of aspect 19 in the present invention includes: a prism-shaped substrate that has a bottom surface and a side surface connected to the bottom surface and includes a light transmission portion; and a metalized film provided on at least a portion of the side surface of the substrate and having a high wettability for solder, wherein a solder blocking portion having a low wettability for solder is provided on at least a portion of the side surface of the substrate.

An electronic device of aspect 20 in the present invention includes: a housing having an opening; and the light transmission window member according to any one of aspects 1 to 14 and fitted in the opening of the housing.

An electronic device of aspect 21 is the electronic device according to aspect 20, wherein a surface of the housing in which the opening is provided may be provided in substantially the same plane as a surface of the light transmission window member located on a light exit side.

### Advantageous Effects of Invention

The present invention enables provision of: a light transmission window member that, when used in an electronic device, such as a wearable device, can provide an excellent feeling of use and aesthetic quality and can make it less likely that a light intensity loss occurs; a method for manufacturing the light transmission window member; a prism; and an electronic device.

### BRIEF DESCRIPTION OF DRAWINGS

FIG. 1(a) is a schematic plan view showing a light transmission window member according to a first embodiment of the present invention and FIG. 1(b) is a schematic cross-sectional view showing a portion of the light transmission window member taken along the line A-A.

FIG. 2 is a schematic cross-sectional view showing in magnification a portion where a metalized film is provided in FIG. 1(b).

FIG. 3 is a schematic cross-sectional view for illustrating how the light transmission window member according to the first embodiment of the present invention is mounted to a housing of an electronic device.

FIG. 4 is a schematic cross-sectional view showing a first modification of the light transmission window member according to the first embodiment of the present invention.

FIG. 5 is a schematic cross-sectional view showing a second modification of the light transmission window member according to the first embodiment of the present invention.

FIG. 6 is a graph showing an example of optical properties of a portion where an antireflection film is provided.

FIG. 7 is a schematic plan view for illustrating a method for manufacturing the light transmission window member according to the first embodiment of the present invention.

FIG. 8 is a schematic cross-sectional view showing an electronic device according to the first embodiment of the present invention.

FIG. 9 is a schematic view showing a prism and an electronic device according to a second embodiment of the present invention.

FIG. 10 is a schematic view of the prism in FIG. 9 as viewed from a light entrance surface side.

FIG. 11 is a schematic view of the prism in FIG. 9 as viewed from a light reflection surface side.

FIG. 12 is a schematic view showing a modification of the prism according to the second embodiment of the present invention.

FIG. 13 is a schematic cross-sectional view for illustrating how a light transmission window member in a comparative example is mounted to a housing of an electronic device.

FIG. 14 is a schematic cross-sectional view showing a modification of a portion where a metalized film is provided.

### DESCRIPTION OF EMBODIMENTS

Hereinafter, a description will be given of preferred embodiments. However, the following embodiments are merely illustrative and the present invention is not limited to the following embodiments. Throughout the drawings, members having substantially the same functions may be referred to by the same reference characters.

### First Embodiment

### (Light Transmission Window Member)

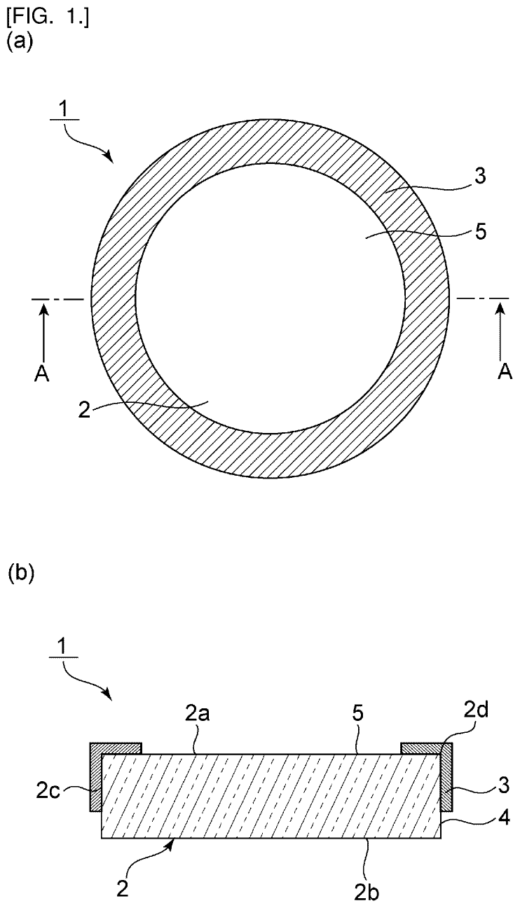

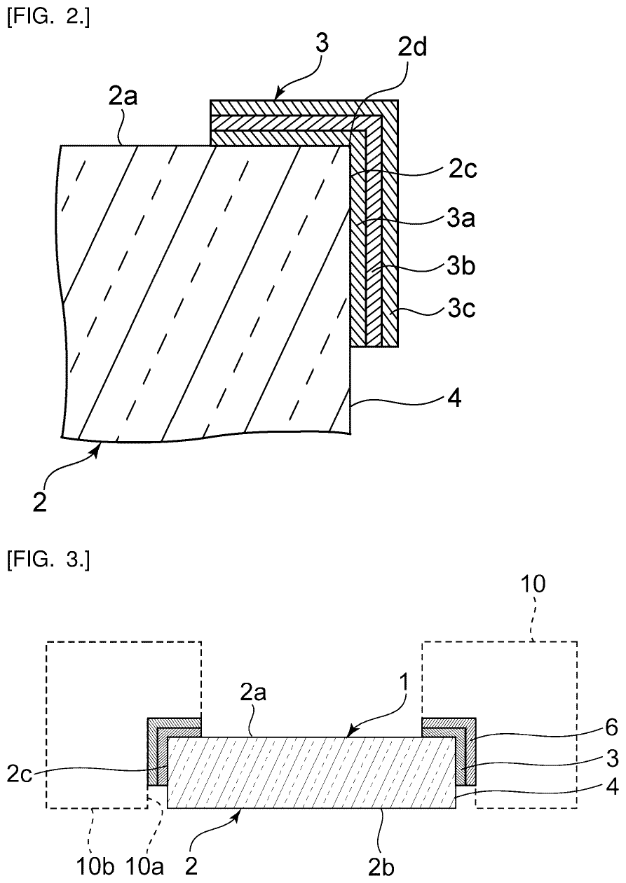

FIG. 1(a) is a schematic plan view showing a light transmission window member according to a first embodiment of the present invention and FIG. 1(b) is a schematic cross-sectional view showing a portion of the light transmission window member taken along the line A-A. FIG. 2 is a schematic cross-sectional view showing in magnification a portion where a metalized film is provided in FIG. 1(b).

As shown in FIGS. 1(a) and 1(b), a light transmission window member 1 includes a substrate 2 and a metalized film 3. The substrate 2 includes a light transmission portion 5.

The shape of the substrate 2 is a plate-like shape. Particularly, in this embodiment, the shape in plan of the substrate 2 is circular. Furthermore, the shape in plan of the light transmission portion 5 is also circular. However, in the present invention, the shape in plan of the substrate 2 may be approximately circular, approximately rectangular including rectangular or approximately polygonal including polygonal. The shape in plan of the light transmission portion 5 may also be approximately circular, approximately rectangular including rectangular or approximately polygonal including polygonal. The shape in plan of the light transmission portion 5 is preferably the same as that of the substrate 2. Although the substrate 2 may be in the shape of a flat plate as in this embodiment, it may have a single or plurality of bumps or dips or may have an approximately plate-like shape in which one of the principal surfaces is convexly or concavely curved.

The type of the substrate 2 is not particularly limited and, for example, a transparent substrate may be used. The substrate 2 preferably has an extinction coefficient k of 1×10⁻⁷ or less in a wavelength range of 1200 nm to 2500 nm. Furthermore, its extinction coefficient k in a wavelength range of 800 nm to 2500 nm is preferably 1×10⁻⁷ or less. Thus, for example, the substrate 2 can easily transmit near infrared rays emitted from an LED. Examples of the material for the substrate 2 like this that can be used include sapphire, silicon wafer, and glass. Examples of the glass that can be used include optical glasses, including borosilicate glass and quartz glass.

The extinction coefficient k in a wavelength range of 800 nm and less is not particularly limited, but may be selected according to the purpose. For example, when the transparency in the visible light range is desired, the extinction coefficient k in a wavelength range of 400 nm to 800 nm is preferably 1×10⁻⁷ or less. Alternatively, when the hideability in the visible light range is desired, the extinction coefficient k in a wavelength range of 400 nm to 800 nm is preferably 1 or more.

The substrate 2 has a first principal surface 2a and a second principal surface 2b opposed to each other. The first principal surface 2a is a principal surface provided on a light entrance side. The second principal surface 2b is a principal surface provided on a light exit side. Furthermore, the substrate 2 has a side surface 2c connecting the first principal surface 2a and the second principal surface 2b.

The thickness of the substrate 2 is not particularly limited, and may be, for example, not less than 0.1 mm and not more than 10 mm. From the viewpoint of further reducing the size of an electronic device, such as a wearable device, the thickness of the substrate 2 is preferably not more than 5 mm, more preferably not more than 3 mm, even more preferably not more than 2 mm, and particularly preferably not more than 1 mm. From the viewpoint of more certainly avoiding breakage, the thickness of the substrate 2 is preferably not less than 0.2 mm and more preferably not less than 0.3 mm. Furthermore, the substrate 2 may have a single or plurality of bumps or dips on the first principal surface 2a or the first principal surface 2a may have a convexly or concavely curved shape.

The metalized film 3 is provided to spread from the first principal surface 2a to the side surface 2c of the substrate 2. More specifically, the metalized film 3 has, on the first principal surface 2a of the substrate 2, a frame-like shape along the peripheral portion of the first principal surface 2a. In the first principal surface 2a of the substrate 2, a portion thereof other than where the metalized film 3 is provided constitutes the light transmission portion 5.

Furthermore, the metalized film 3 is also provided on a portion of the side surface 2c of the substrate 2 nearer the first principal surface 2a. Therefore, the metalized film 3 is also provided on a corner portion 2d of the substrate 2 connecting the first principal surface 2a and the side surface 2c. However, in the present invention, the metalized film 3 may be provided only on the side surface 2c of the substrate 2. In this case, the whole of the first principal surface 2a and the whole of the second principal surface 2b can be used as the light transmission portion 5 and, therefore, an electronic device, such as a wearable device, can be more easily reduced in size.

The metalized film 3 is preferably a film having a high wettability for solder. Herein, the expression “high wettability for solder” means that the contact angle of solder, which is an angle formed between solder and the film, is 90° or less. In this case, the affinity between solder and the film is high and the solder can get wetter and easily spread.

As shown in FIG. 2, in this embodiment, the metalized film 3 includes a adhesion layer 3a, an anti-diffusion layer 3b, and a solder bonding layer 3c. The adhesion layer 3a is in contact with the first principal surface 2a and the side surface 2c of the substrate 2. The anti-diffusion layer 3b is provided on the adhesion layer 3a. The solder bonding layer 3c is provided on the anti-diffusion layer 3b.

The type of the adhesion layer 3a is not particularly limited and an example is a metallic film containing Cr, Ti, Ta, W or so on. The adhesion layer 3a is preferably a metallic film made of at least one of Cr and Ti. The thickness of the adhesion layer 3a is not particularly limited and may be, for example, not less than 0.01 μm and not more than 0.3 μm.

The type of the anti-diffusion layer 3b is not particularly limited and an example is a metallic film containing Ni, Pt, Pd, W or so on. The anti-diffusion layer 3b is preferably a metallic film made of at least one selected from the group consisting of Ni, Pt and Pd. The thickness of the anti-diffusion layer 3b is not particularly limited and may be, for example, not less than 0.1 μm and not more than 1 μm.

The solder bonding layer 3c is preferably made of a material having a high wettability for solder. An example of the solder bonding layer 3c is a metallic film containing Au, Pt or so on. The solder bonding layer 3c is preferably a metallic film made of at least one of Au and Pt. The thickness of the solder bonding layer 3c is not particularly limited and may be, for example, not less than 0.1 μm and not more than 1 μm.

As shown as a modification in FIG. 14, the metalized film 3 may be reduced in thickness on the side surface 2c of the substrate 2 with distance from the first principal surface 2a. In other words, the metalized film 3 may be gradually reduced in thickness on the side surface 2c of the substrate 2 from the side of the metalized film 3 nearer the first principal surface 2a toward the side thereof nearer the second principal surface 2b.

More specifically, each of the adhesion layer 3a, the anti-diffusion layer 3b, and the solder bonding layer 3c may be reduced in thickness on the side surface 2c of the substrate 2 with distance from the first principal surface 2a. In other words, each of the adhesion layer 3a, the anti-diffusion layer 3b, and the solder bonding layer 3c may be gradually reduced in thickness on the side surface 2c of the substrate 2 from their sides nearer the first principal surface 2a toward their sides nearer the second principal surface 2b.

As thus far described, in the present invention, the thickness of the metalized film 3 may be uniform or may differ from region to region where the metalized film 3 is provided. Furthermore, each of the adhesion layer 3a, the anti-diffusion layer 3b, and the solder bonding layer 3c may be uniform in thickness or may vary its thickness from region to region where it is provided.

The thickness of the metalized film 3 is not particularly limited and may be, for example, not less than 0.2 μm and not more than 3.6 μm. Alternatively, the thickness of the metalized film 3 may be not less than 0.31 μm and not more than 2.3 μm. In particular, the ratio between the thickness of the metalized film 3 on the first preferably 2a and the thickness of the metalized film 3 on the side surface 2c ((thickness on side surface 2c)/(thickness on first principal surface 2a)) is not particularly limited, but is preferably not less than 0.40, more preferably not less than 0.50, even more preferably not less than 0.55, still even more preferably not less than 0.60, yet still even more preferably not less than 0.65, yet still even more preferably not less than 0.70, yet still even more preferably not less than 0.75, yet still even more preferably not less than 0.80, and particularly preferably not less than 0.85, preferably not more than 0.99, more preferably not more than 0.97, even more preferably not more than 0.95, still even more preferably not more than 0.93, and particularly preferably not more than 0.90. In this case, in depositing the metalized film 3 on the side surface 2c to a predetermined thickness, it can be deposited for a short time, which increases the productivity. For example, when the thickness ratio is within the above range, it is not necessary to make the metalized film 3 on the first principal surface 2a excessively thick. Therefore, warpage of the substrate due to film stress can be reduced and, as a result, for example, an opening of an electronic device can be more certainly sealed using solder. In addition, the solder can be more effectively made difficult to protrude. When the thickness of the metalized film 3 on the first principal surface 2a is not uniform, a thickness obtained by averaging the maximum thickness thereof and the minimum thickness thereof is adopted as the thickness of the metalized film 3 on the first principal surface 2a. Furthermore, when the thickness of the metalized film 3 on the side surface 2c is not uniform, the thickness thereof at a distance half the length of the side surface 2c is adopted as the thickness of the metalized film 3 on the side surface 2c.

The thickness of the adhesion layer 3a is not particularly limited and may be, for example, not less than 0.01 μm and not more than 0.3 μm. The ratio between the thickness of the adhesion layer 3a on the first principal surface 2a and the thickness of the adhesion layer 3a on the side surface 2c ((thickness on side surface 2c)/(thickness on first principal surface 2a)) is not particularly limited, but is preferably not less than 0.40, more preferably not less than 0.50, even more preferably not less than 0.55, still even more preferably not less than 0.60, yet still even more preferably not less than 0.65, yet still even more preferably not less than 0.70, yet still even more preferably not less than 0.75, yet still even more preferably not less than 0.80, and particularly preferably not less than 0.85, preferably not more than 0.99, more preferably not more than 0.97, even more preferably not more than 0.95, still even more preferably not more than 0.93, and particularly preferably not more than 0.90. In this case, in forming the adhesion layer 3a on the side surface 2c to a predetermined thickness, it can be formed for a short time, which increases the productivity. Furthermore, in sealing an opening of an electronic device or the like using solder, the solder can be more effectively made difficult to protrude. When the thickness of the adhesion layer 3a on the first principal surface 2a is not uniform, a thickness obtained by averaging the maximum thickness thereof and the minimum thickness thereof is adopted as the thickness of the adhesion layer 3a on the first principal surface 2a. Furthermore, when the thickness of the adhesion layer 3a on the side surface 2c is not uniform, the thickness thereof at a distance half the length of the side surface 2c is adopted as the thickness of the adhesion layer 3a on the side surface 2c.

The thickness of the anti-diffusion layer 3b is not particularly limited and may be, for example, not less than 0.1 μm and not more than 1 μm. The ratio between the thickness of the anti-diffusion layer 3b on the first principal surface 2a and the thickness of the anti-diffusion layer 3b on the side surface 2c ((thickness on side surface 2c)/(thickness on first principal surface 2a)) is not particularly limited, but is preferably not less than 0.05, not less than 0.10, not less than 0.15, not less than 0.20, not less than 0.25, not less than 0.30, not less than 0.35, not less than 0.40, not less than 0.50, not less than 0.55, not less than 0.60, not less than 0.65, not less than 0.70, not less than 0.75, not less than 0.80, and particularly preferably not less than 0.85, preferably not more than 1.00, more preferably not more than 0.99, even more preferably not more than 0.97, still even more preferably not more than 0.95, yet still even more preferably not more than 0.93, and particularly preferably not more than 0.90. In this case, in forming the anti-diffusion layer 3b on the side surface 2c to a predetermined thickness, it can be formed for a short time, which increases the productivity. Furthermore, in sealing an opening of an electronic device or the like using solder, the solder can be more effectively made difficult to protrude. When the thickness of the anti-diffusion layer 3b on the first principal surface 2a is not uniform, a thickness obtained by averaging the maximum thickness thereof and the minimum thickness thereof is adopted as the thickness of the anti-diffusion layer 3b on the first principal surface 2a. Furthermore, when the thickness of the anti-diffusion layer 3b on the side surface 2c is not uniform, the thickness thereof at a distance half the length of the side surface 2c is adopted as the thickness of the anti-diffusion layer 3b on the side surface 2c.

The thickness of the solder bonding layer 3c is not particularly limited and may be, for example, not less than 0.1 μm and not more than 1 μm. The ratio between the thickness of the solder bonding layer 3c on the first principal surface 2a and the thickness of the solder bonding layer 3c on the side surface 2c ((thickness on side surface 2c)/(thickness on first principal surface 2a)) is not particularly limited, but is preferably not less than 0.40, more preferably not less than 0.50, even more preferably not less than 0.55, still even more preferably not less than 0.60, yet still even more preferably not less than 0.65, yet still even more preferably not less than 0.70, yet still even more preferably not less than 0.75, yet still even more preferably not less than 0.80, and particularly preferably not less than 0.85, preferably not more than 0.99, more preferably not more than 0.95, even more preferably not more than 0.93, and particularly preferably not more than 0.90. In this case, in forming the solder bonding layer 3c on the side surface 2c to a predetermined thickness, it can be formed for a short time, which increases the productivity. Furthermore, in sealing an opening of an electronic device or the like using solder, the solder can be more effectively made difficult to protrude. When the thickness of the solder bonding layer 3c on the first principal surface 2a is not uniform, a thickness obtained by averaging the maximum thickness thereof and the minimum thickness thereof is adopted as the thickness of the solder bonding layer 3c on the first principal surface 2a. Furthermore, when the thickness of the solder bonding layer 3c on the side surface 2c is not uniform, the thickness thereof at a distance half the length of the side surface 2c is adopted as the thickness of the solder bonding layer 3c on the side surface 2c.

In the present invention, it is sufficient that the metalized film 3 includes as its outermost layer the solder bonding layer 3c and the adhesion layer 3a and the anti-diffusion layer 3b may not necessary be provided. However, in order to further increase the air-tight sealing properties, the metalized film 3 preferably includes all of the adhesion layer 3a, the anti-diffusion layer 3b, and the solder bonding layer 3c.

A solder blocking portion 4 is provided on the side surface 2c of the substrate 2. The solder blocking portion 4 is preferably a portion having a low wettability for solder. Herein, the expression “low wettability for solder” means that the contact angle of solder, which is an angle formed between solder and the solder blocking portion 4, is over 90°. The solder blocking portion 4 is preferably a portion having a lower wettability for solder than the metalized film 3. In this case, the affinity between solder and the solder blocking portion 4 is high and the solder can get wetter and easily spread. In this embodiment, the solder blocking portion 4 is a portion of the side surface 2c which is other than where the metalized film 3 is provided and in which the substrate 2 is exposed.

Furthermore, the solder blocking portion 4 is provided in a region of the side surface 2c which is nearer the second principal surface 2b and on which the metalized film 3 is not provided. More specifically, the solder blocking portion 4 is provided on the side surface 2c to extend in a thickness direction from the second principal surface 2b. Herein, the thickness direction is a direction connecting the first principal surface 2a and the second principal surface 2b.

The solder blocking portion 4 is preferably provided in a region of the side surface 2c extending 5% to less than 100% of the entire thickness of the side surface 2c in the thickness direction from the second principal surface 2b, more preferably in a region thereof extending 5 to 98% of the entire thickness, even more preferably in a region thereof extending 6% to 95% of the entire thickness, still even more preferably in a region thereof extending 6% to 90% of the entire thickness, yet still even more preferably in a region thereof extending 7% to 80% of the entire thickness, yet still even more preferably in a region thereof extending 8% to 70% of the entire thickness, yet still even more preferably in a region thereof extending 9% to 60% of the entire thickness, yet still even more preferably in a region thereof extending 10% to 50% of the entire thickness, and particularly preferably provided in a region thereof extending 15% to 30% of the entire thickness. In other words, the solder blocking portion 4 is preferably provided in a region of the side surface 2c extending not less than 5%, not less than 6%, not less than 7%, not less than 8%, not less than 9%, not less than 10%, and particularly not less than 15% in the thickness direction from the second principal surface 2b, and preferably provided in a region of the side surface 2c extending less than 100%, not more than 98%, not more than 95%, not more than 92%, not more than 90%, not more than 85%, not more than 80%, not more than 70%, not more than 60%, not more than 50%, and particularly not more than 30% in the thickness direction from the second principal surface 2b.

When the outer circumferential direction of the second principal surface 2b is considered a peripheral direction thereof, the solder blocking portion 4 may be provided entirely with respect to the peripheral direction of the second principal surface 2b or may be provided partially along the peripheral direction of the second principal surface 2b. The solder blocking portion 4 is preferably provided, with respect to the peripheral direction of the second principal surface 2b, 50% to 100%, more preferably not less than 60%, even more preferably not less than 70%, still even more preferably not less than 80%, and particularly preferably not less than 90% of the entire peripheral length of the second principal surface 2b. The upper limit is not particularly set and may be, for example, not more than 99%, not more than 98%, not more than 97%, not more than 95%, not more than 92% or not more than 90%.

In the light transmission window member 1 according to this embodiment, the solder blocking portion 4 is provided in the side surface 2c of the substrate 2. Therefore, when used in an electronic device, such as a wearable device, the light transmission window member 1 according to this embodiment can provide an excellent feeling of use and aesthetic quality and can make it less likely that a light intensity loss occurs. This will be described below in detail.

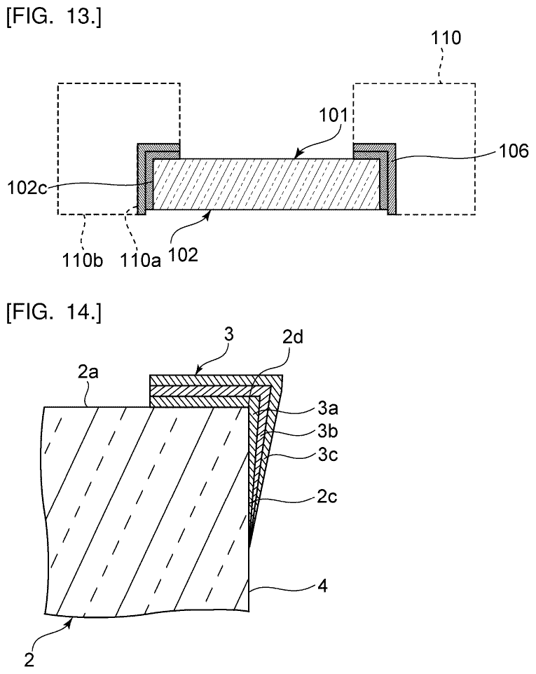

Conventionally, a wearable device, such as a smartwatch, may be used with a light transmission window member disposed on the wrist (the skin) side of the wearable device. More specifically, the wearable device may be used with an opening in its housing disposed on the wrist (the skin) side and a light transmission window member fitted in the opening. If in this case it is sought to, as shown as a comparative example in FIG. 13, dispose solder 106 over the entire side surface 102c of a substrate 102 to surely seal an opening 110a with the solder 106, the solder will protrude from the opening 110a and, therefore, it is difficult to dispose a housing 110 and a light transmission window member 101 in the same plane along the surface 110b of the wearable device nearest the wrist (the skin). For this reason, the substrate 102 is disposed slightly above the surface 110b of the wearable device nearest the wrist (the skin), which may form a level difference (a recess). If such a recess is formed, this may cause a sense of discomfort for such reasons as retention of sweat into the recess during wearing of the device or may cause a loss of light intensity to be measured. Furthermore, the solder 106 comes into sight when the wearable device is viewed from the wrist (the skin) side and, therefore, the aesthetic quality of the wearable device may be impaired.

Unlike the above, in the light transmission window member 1 according to this embodiment, the solder 6 is provided on a portion of the side surface 2c nearer the first principal surface 2a as shown in FIG. 3. Furthermore, since the solder blocking portion 4 is provided in a region of the side of the second principal surface 2b, the solder 6 is difficult to protrude to the region of the side of the second principal surface 2b. Therefore, the housing 10 and the light transmission window member 1 can be disposed substantially in the same plane along the surface 10b of the housing 10 nearest the wrist (the skin) and they are less likely to form a level difference (a recess) between them. Hence, a sense of discomfort for such reasons as retention of sweat during wearing of a wearable device is less likely to occur and a loss of light intensity to be measured is less likely to occur. In addition, the solder 6 is out of sight when the wearable device is viewed from the wrist (the skin) side and, therefore, the aesthetic quality of the wearable device is less likely to be impaired. Hence, when used in an electronic device, such as a wearable device, the light transmission window member 1 can provide an excellent feeling of use and aesthetic quality and can make it less likely that a light intensity loss occurs.

The light transmission window member 1 according to this embodiment may include the solder 6 on the metalized film 3. Examples of the solder 6 that can be used include metals containing Au, Sn or In. Among them, for example, an Au—Sn alloy or an Au—Ge alloy can be used as a solder 6 having a high melting point. Alternatively, a Sn-based metal or an In-based metal can be used as a solder 6 having a low melting point. The solder 6 may be a layered film in which Au layers and Sn layers are alternately layered.

For example, a solder in a ring preform or in paste form can be used as the solder 6. For example, when the solder 6 in a ring preform or in paste form is placed on the first principal surface 2a and then melted, the solder 6 can be spread to around the side surface 2c. The solder 6 spread to around the side surface 2c can be prevented from protruding to the region of the side surface 2c nearer the second principal surface 2b by the solder blocking portion 4.

Although in the above embodiment the light transmission portion 5 is provided on the first principal surface 2a, a reflective film that reflects a particular wavelength and transmits a particular wavelength may be further provided on the first principal surface 2a. An example of the reflective film that can be used is a dielectric multilayer film in which high-refractive index films and low-refractive index films are alternately layered. Examples of the material for the high-refractive index films include TiO₂, Ta₂O₅, ZrO₂, and HfO₂. Examples of the material for the low-refractive index films include SiO₂ and MgF₂. The reflective film may be a monolayer metal film and the type thereof is not particularly limited. The thickness of the reflective film may be, for example, not less than 70 nm and not more than 300 nm. The reflective film can be formed by layering each layer, for example, by a sputtering method or a vacuum evaporation method.

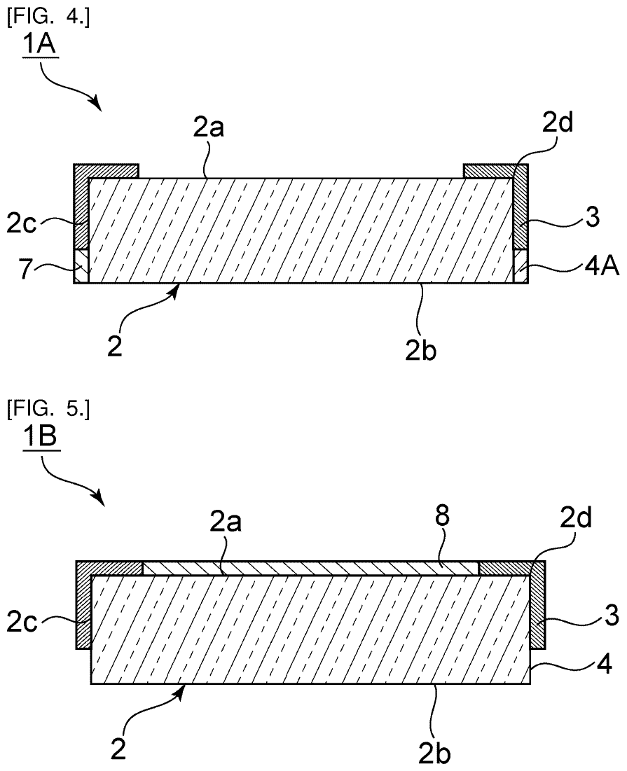

In the above embodiment, the solder blocking portion 4 is constituted by a portion which is other than where the metalized film 3 is provided and in which the substrate 2 is exposed. However, in the present invention, as in a light transmission window member 1A according to a first modification shown in FIG. 4, a solder blocking portion 4A may be constituted by an inorganic film 7 being provided on a portion of the side surface 2c of the substrate 2 nearer the second principal surface 2b, the inorganic film 7 having a low wettability for solder. The type of the inorganic film 7 is not particularly limited and, for example, an oxide film, a nitride film, a fluoride film or a sulfide film can be used as the inorganic film 7. Examples of the material for the oxide film that can be used include SiO₂ and Al₂O₃. Examples of the material for the nitride film that can be used include Si₃N₄ and AlN. An example of the material for the fluoride film that can be used is MgF₂. An example of the material for the sulfide film that can be used is ZnS.

Furthermore, as in a light transmission window member 1B according to a second modification shown in FIG. 5, an antireflection film 8 may be further provided on a region of the first principal surface 2a of the substrate 2 where the light transmission portion 5 is provided. An example of the antireflection film 8 that can be used is a dielectric multilayer film in which high-refractive index films and low-refractive index films are alternately layered. Examples of the material for the high-refractive index films that can be used include Ta₂O₅, TiO, TiO₂, Nb₂O₅, HfO₂, ZrO₂, Si₃N₄, and Si. Examples of the material for the low-refractive index films that can be used include SiO, SiO₂, and MgF₂. Other than the above materials, a material for a medium-refractive index film may be used. For example, Al₂O₃ may be used as the material for a medium-refractive index film. The thickness of the high-refractive index films may be, for example, not less than 30 nm and not more than 400 nm. The thickness of the low-refractive index films may be, for example, not less than 15 nm and not more than 400 nm. The entire thickness of the antireflection film 8 may be, for example, not less than 400 nm and not more than 2500 nm. The antireflection film 8 can be formed by layering each layer, for example, by a sputtering method or a vacuum evaporation method.

The portion where the antireflection film 8 is provided preferably has, in a wavelength range of 1200 nm to 1700 nm, a reflectance of not more than 1% and more preferably a reflectance of not more than 0.5%. From the viewpoint of making the interior of the housing less visible to further increase the aesthetic appearance, the portion where the antireflection film 8 is provided preferably does not transmit light in the visible wavelength range. More specifically, the portion where the antireflection film 8 is provided preferably has, in a wavelength range of 450 nm to 700 nm, an average reflectance of not less than 10%, more preferably an average reflectance of not less than 20%, and particularly preferably an average reflectance of not less than 40%.

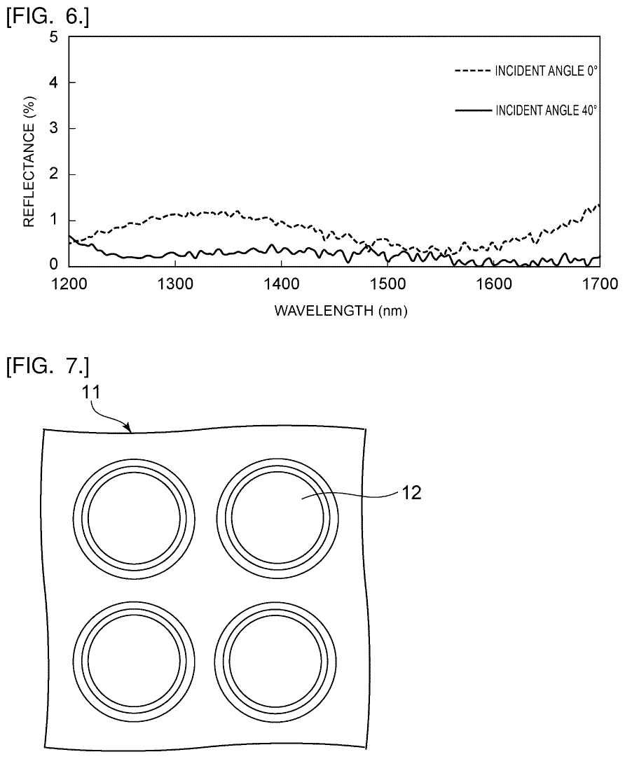

FIG. 6 is a graph showing an example of optical properties of a portion where an antireflection film is provided. FIG. 6 shows 1200-1700 nm wavelength range reflectances of a portion where an antireflection film 8 formed by layering Ta₂O₅ (thickness: 67 nm), SiO₂ (thickness: 58 nm), Ta₂O₅ (thickness: 197 nm), and SiO₂ (thickness: 254 nm) in this order on the substrate 2 is provided. The portion where this antireflection film 8 is provided is increased in reflectance in the visible wavelength range.

Although in the above embodiment the reflective film or the antireflection film 8 is provided on a region of the first principal surface 2a of the substrate 2 where the light transmission portion 5 is provided, the reflective film or the antireflection film 8 may be provided on the second principal surface 2b of the substrate 2 as another embodiment.

Alternatively, as still another embodiment, the reflective film or the antireflection film 8 may be provided on each of the first principal surface 2a and the second principal surface 2b of the substrate 2.

Furthermore, a protective film for prevention of scratching may be provided on each of the first principal surface 2a and the second principal surface 2b of the substrate 2. Examples of the material for the protective film include SiO₂, SiO, Al₂O₃, Si₃N₄, and MgF₂. The thickness of the protective film may be, for example, not less than 10 nm and not more than 300 nm.

Hereinafter, a description will be given of an example of a method for manufacturing the light transmission window member 1.

### (Method for Manufacturing Light Transmission Window Member)

FIG. 7 is a schematic plan view for illustrating a method for manufacturing the light transmission window member according to the first embodiment of the present invention.

In the method for manufacturing the light transmission window member 1, first, a substrate 2 is prepared. Next, using a film-forming jig 11, a mask 12 is placed in contact with the first principal surface 2a of the substrate 2. The mask 12 is placed to mask a portion where a light transmission portion 5 is to be formed during film deposition. Furthermore, a portion where a solder blocking portion 4 is to be formed is also masked.

Next, in a state where portions of the first principal surface 2a and the side surface 2c other than where a metalized film is to be formed are masked by the film-forming jig 11, a metalized film 3 is deposited. Thus, a light transmission window member 1 can be formed.

The deposition of the metalized film 3 can be achieved, for example, by an evaporation method or a sputtering method. Examples of the evaporation method include a vacuum evaporation method, an ion plating vacuum evaporation method, and an ion-assisted vacuum evaporation method.

In depositing the metalized film 3, by adjusting the direction of deposition or the time for deposition, the ratio of the thickness of the metalized film 3 on the side surface 2c to the thickness of the metalized film 3 on the first principal surface 2a ((thickness on side surface 2c)/(thickness on first principal surface 2a)) can be adjusted to a desired value. For example, in the case where the film is deposited from the direction facing the first principal surface 2a as the direction of deposition or in reducing the time for deposition to a short time, the thickness of the metalized film 3 on the first principal surface 2a is likely to be larger than the thickness of the metalized film 3 on the side surface 2c and, therefore, the ratio of the thickness of the metalized film 3 on the side surface 2c to the thickness of the metalized film 3 on the first principal surface 2a ((thickness on side surface 2c)/(thickness on first principal surface 2a)) can be adjusted to a small value. Furthermore, the metalized film 3 can be provided to gradually reduce, on the side surface 2c of the substrate 2, the thickness in the thickness direction from the side thereof nearer the first principal surface 2a toward the side thereof nearer the second principal surface 2b. This can make it even less likely that the solder 6 protrudes to a region of the side of the second principal surface 2b.

On the other hand, for example, by increasing the pressure during film deposition, spreading of the solder to around the side surface 2c can be increased to bring the ratio of the thickness of the metalized film 3 on the side surface 2c to the thickness of the metalized film 3 on the first principal surface 2a ((thickness on side surface 2c)/(thickness on first principal surface 2a)) close to 1. Thus, a light transmission window member 1 including a metalized film 3 having a more uniform thickness can be easily obtained.

Although the above description has been given by taking as an example the metalized film 3, the similar deposition conditions can also be applied, needless to say, to the adhesion layer 3a, the anti-diffusion layer 3b, and the solder bonding layer 3c, also in which case the same effects as for the metalized film 3 can be obtained.

### (Electronic Device)

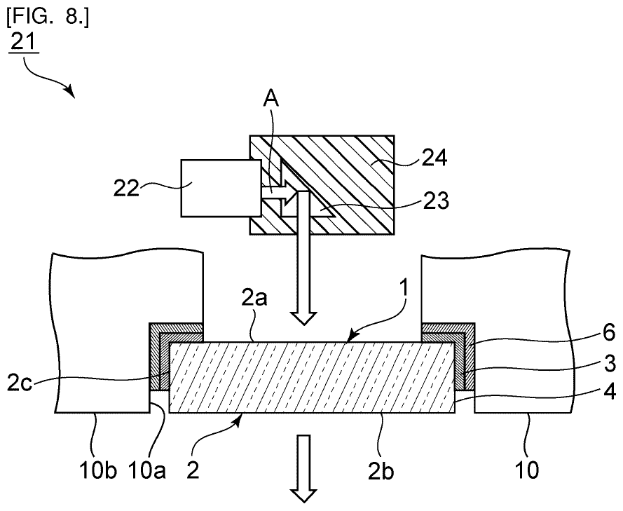

FIG. 8 is a schematic cross-sectional view showing an electronic device according to the first embodiment of the present invention. As shown in FIG. 8, an electronic device 21 includes a light transmission window member 1 and a housing 10. The light transmission window member 1 is fitted into an opening 10a of the housing 10. The material for the housing 10 is not particularly limited and, for example, aluminum, stainless steel or resin can be used.

In the electronic device 21, light A having exited a light source 22 is reflected by a prism 23, passes through the light transmission window member 1 and is then applied to an object to be irradiated. Examples of the light source 22 that can be used include an LD and an LED.

In this embodiment, the light source 22 and the prism 23 are disposed in the interior of the housing 10. However, in the present invention, the light source 22 and the prism 23 may be disposed outside the housing 10. Furthermore, as shown in FIG. 8, a refractive index matching resin 24 may be provided between the light source 22 and the prism 23. The material for the refractive index matching resin 24 is not particularly limited and, for example, acrylic resin, polycarbonate resin or silicone resin can be used.

In the electronic device 21 according to this embodiment, the light transmission window member 1 is fitted into the opening 10a of the housing 10. In the light transmission window member 1, solder 6 is provided on a portion of the side surface 2c nearer the first principal surface 2a. Furthermore, a solder blocking portion 4 is provided in a region of the side surface 2c nearer the second principal surface 2b and, therefore, the solder 6 does not protrude to the region of the side surface 2c nearer the second principal surface 2b. Therefore, in the electronic device 21, the housing 10 and the light transmission window member 1 can be disposed substantially in the same plane along the surface 10b of the housing 10 nearer the object to be irradiated and they are less likely to form a level difference (a recess) between them. Hence, when a wearable device is used as the electronic device 21, a sense of discomfort for such reasons as retention of sweat during wearing of the wearable device is less likely to occur and a loss of light intensity to be measured is less likely to occur. In addition, the solder 6 is out of sight when the wearable device is viewed from the object to be irradiated side and, therefore, the aesthetic quality of the wearable device is less likely to be impaired. Hence, the electronic device 21 can increase the feeling of use and aesthetic quality and can make it less likely that a light intensity loss occurs. As seen from the above, the electronic device 21 can be suitably used, for example, as a wearable device, such as a smartwatch.

### Second Embodiment

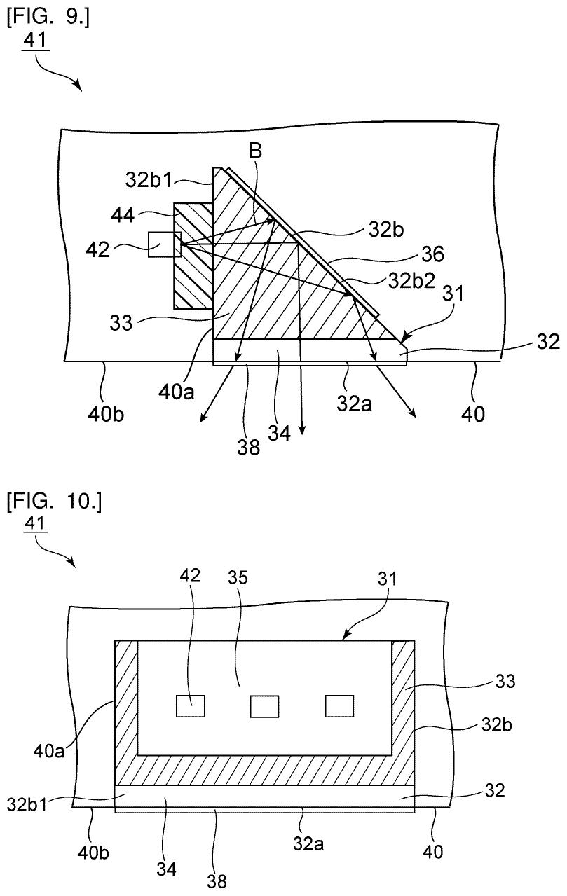

FIG. 9 is a schematic view showing a prism and an electronic device according to a second embodiment of the present invention. FIG. 10 is a schematic view of the prism in FIG. 9 as viewed from a light entrance surface side. FIG. 11 is a schematic view of the prism in FIG. 9 as viewed from a light reflection surface side. FIGS. 9 to 11 show schematic cross-sectional views of the prism and the electronic device according to the second embodiment, wherein only a portion where a metalized film is provided is shown by hatching.

A prism 31 includes: a prism-shaped substrate 32 including a light transmission portion 35; a metalized film 33; a reflective film 36; and an antireflection film 38. In this embodiment, the cross-sectional shape of the substrate 32 is approximately triangular. The substrate 32 has a bottom surface 32a and a side surface 32b connected to the bottom surface 32a. The side surface 32b includes a light entrance surface 32b1 and a reflecting surface 32b2.

The type of the substrate 32 is not particularly limited and, for example, a transparent substrate may be used. The substrate 32 preferably has an extinction coefficient k of 1×10⁻⁷ or less in a wavelength range of 1200 nm to 2500 nm. Furthermore, its extinction coefficient k in a wavelength range of 800 nm to 2500 nm is preferably 1×10⁻⁷ or less. Examples of the material for the substrate 32 like this that can be used include sapphire, silicon wafer, and glass. Examples of the glass include optical glasses, such as borosilicate-based glass and quartz.

The extinction coefficient k in a wavelength range of 800 nm and less is not particularly limited, but may be selected according to the purpose. For example, when the transparency in the visible light range is desired, the extinction coefficient k in a wavelength range of 400 nm to 800 nm is preferably 1×10⁻⁷ or less. Alternatively, when the hideability in the visible light range is desired, the extinction coefficient k in a wavelength range of 400 nm to 800 nm is preferably 1 or more.

The metalized film 33 is provided on a portion of the side surface 32b of the substrate 32. The metalized film 33 is not provided on a portion of the side surface 32b of the substrate 32 nearer the bottom surface 32a. Furthermore, as shown in FIG. 10, the metalized film 33 is not provided on the light transmission portion 35 of the light entrance surface 32b1. Moreover, as shown in FIG. 11, the metalized film 33 is provided to cover the reflective film 36 on the reflective surface 32b2. However, the metalized film 33 may not necessarily be provided on a portion where the reflective film 36 is provided.

The metalized film 33 is preferably a film having a high wettability for solder. As the metalized film 33, like the metalized film 3 in the first embodiment, a layered film in which an adhesion layer, an anti-diffusion layer, and a solder bonding layer are layered in this order can be used.

The type of the adhesion layer is not particularly limited and an example is a metallic film containing Cr, Ti, Ta, W or so on. The adhesion layer is preferably a metallic film made of at least one of Cr and Ti.

The type of the anti-diffusion layer is not particularly limited and an example is a metallic film containing Ni, Pt, Pd, W or so on. The anti-diffusion layer is preferably a metallic film made of at least one selected from the group consisting of Ni, Pt, Pd, and W.

The solder bonding layer is preferably made of a material having a high wettability for solder. An example of the solder bonding layer is a metallic film containing Au, Pt or so on. The solder bonding layer is preferably a metallic film made of at least one selected from the group consisting of at least one of Au and Pt.

The thickness of the metalized film 33 is not particularly limited and may be, for example, not less than 0.2 μm and not more than 2.3 μm. The thickness of the adhesion layer is not particularly limited and may be, for example, not less than 0.01 μm and not more than 0.3 μm. The thickness of the anti-diffusion layer is not particularly limited and may be, for example, not less than 0.1 μm and not more than 1 μm. Furthermore, the thickness of the solder bonding layer is not particularly limited and may be, for example, not less than 0.1 μm and not more than 1 μm.

In the present invention, it is sufficient that the metalized film 33 includes as its outermost layer the solder bonding layer and the adhesion layer and the anti-diffusion layer may not necessary be provided. However, in order to further increase the air-tight sealing properties, the metalized film 33 preferably includes all of the adhesion layer, the anti-diffusion layer, and the solder bonding layer.

A solder blocking portion 34 is provided on the side surface 32b of the substrate 32. The solder blocking portion 34 is preferably a portion having a low wettability for solder. In this embodiment, the solder blocking portion 34 is a portion of the side surface 32b which is other than where the metalized film 33 is provided and in which the substrate 32 is exposed. Like the first modification of the first embodiment, the solder blocking portion 34 may be constituted by an inorganic film being provided on the portion, the inorganic film having a low wettability for solder.

Furthermore, the solder blocking portion 34 is provided in a region of the side surface 32b which is nearer the bottom surface 32a and on which the metalized film 33 is not provided. More specifically, the solder blocking portion 34 is provided on the side surface 32b to extend from the bottom surface 32a.

The solder blocking portion 34 is preferably provided in a region of the side surface 32b extending 5% to 95% of the entire thickness of the side surface 32b in the thickness direction from the bottom surface 32a, more preferably in a region thereof extending 5% to 80% of the entire thickness, even more preferably in a region thereof extending 6% to 70% of the entire thickness, still even more preferably in a region thereof extending 7% to 60% of the entire thickness, yet still even more preferably in a region thereof extending 8% to 50% of the entire thickness, yet still even more preferably in a region thereof extending 9% to 40% of the entire thickness, yet still even more preferably in a region thereof extending 10% to 30% of the entire thickness, and particularly preferably provided in a region thereof extending 10% to 25% of the entire thickness.

When the perimetric direction of the bottom surface 32a is considered a peripheral direction thereof, the solder blocking portion 34 may be provided entirely with respect to the peripheral direction of the bottom surface 32a or may be provided partially along the peripheral direction of the bottom surface 32a. The solder blocking portion 34 is preferably provided, with respect to the peripheral direction, 50% to 100%, more preferably not less than 60%, even more preferably not less than 70%, still even more preferably not less than 80%, and particularly preferably not less than 90% of the entire peripheral length. The upper limit is not particularly set and may be, for example, not more than 99%, not more than 98%, not more than 97%, not more than 95%, not more than 92%, not more than 90%, not more than 85%, not more than 80%, not more than 75% or not more than 70%. In the case where an inorganic film having a low wettability for solder is provided as the solder blocking portion, the solder blocking portion is preferably not provided on the light entrance surface 32b1 or preferably provided on the light entrance surface 32b1 within a range of 20% or less in the thickness direction from the bottom surface 32a.

The reflective film 36 is provided on the reflective surface 32b2 of the substrate 32. An example of the reflective film 36 that can be used is a dielectric multilayer film in which high-refractive index films and low-refractive index films are alternately layered. Examples of the material for the high-refractive index films include TiO₂, Ta₂O₅, ZrO₂, and HfO₂. Examples of the material for the low-refractive index films include SiO₂ and MgF₂. The reflective film 36 may be a monolayer metal film and the type thereof is not particularly limited. The thickness of the reflective film 36 may be, for example, not less than 70 nm and not more than 500 nm. The reflective film 36 can be formed by layering each layer, for example, by a sputtering method or a vacuum evaporation method.

The antireflection film 38 is provided on the bottom surface 32a of the substrate 32. An example of the antireflection film 38 that can be used is a dielectric multilayer film in which high-refractive index films and low-refractive index films are alternately layered. Examples of the material for the high-refractive index films that can be used include Ta₂O₅, TiO, TiO₂, Nb₂O₅, HfO₂, ZrO₂, and Si. Examples of the material for the low-refractive index films that can be used include SiO, SiO₂, and MgF₂. Other than the above materials, a material for a medium-refractive index film may be used. For example, Al₂O₃ may be used as the material for a medium-refractive index film. The thickness of the high-refractive index films may be, for example, not less than 30 nm and not more than 400 nm. The thickness of the low-refractive index films may be, for example, not less than 15 nm and not more than 400 nm. The entire thickness of the antireflection film 38 may be, for example, not less than 400 nm and not more than 2500 nm. The antireflection film 38 can be formed by layering each layer, for example, by a sputtering method or a vacuum evaporation method. However, the antireflection film 38 may not necessarily be provided.

Furthermore, a protective film for prevention of scratching may be provided on the bottom surface 32a of the substrate 32. Examples of the material for the protective film include SiO₂, SiO, Al₂O₃, and MgF₂. The thickness of the protective film may be, for example, not less than 10 nm and not more than 300 nm.

The method for manufacturing the prism 31 is not particularly limited, but, like the light transmission window member 1 according to the first embodiment, the prism 31 can be manufactured, for example, by masking, with a film-forming jig, a portion of the substrate 32 other than where a metalized film is to be formed and, in this state, depositing a metalized film 33.

An electronic device 41 according to this embodiment includes a prism 31 and a housing 40. The prism 31 is fitted into an opening 40a of the housing 40. The material for the housing 40 is not particularly limited and, for example, aluminum, stainless steel or resin can be used.

In the electronic device 41, light B having exited a light source 42 is reflected by the reflective surface 32b2 of the prism 31, emitted through the bottom surface 32a, and applied to an object to be irradiated. Examples of the light source 42 that can be used include an LD and an LED. In this embodiment, the light source 42 is disposed in the interior of the housing 40. However, in the present invention, the light source 42 may be disposed outside the housing 40. Furthermore, as shown in FIG. 9, a refractive index matching resin 44 may be provided between the light source 42 and the prism 31. The material for the refractive index matching resin 44 is not particularly limited and, for example, acrylic resin, polycarbonate resin or silicone resin can be used.

In the electronic device 41 according to this embodiment, the prism 31 is fitted into the opening 40a of the housing 40. In the prism 31, solder is provided on the metalized film 33. Therefore, the solder is provided on a portion of the side surface 32b. Furthermore, a solder blocking portion 34 is provided in a region of the side surface 32b nearer the bottom surface 32a and, therefore, the solder does not protrude to the region of the side surface 32b nearer the bottom surface 32a. Therefore, in the electronic device 41, the housing 40 and the prism 31 can be disposed substantially in the same plane along the surface 40b of the housing 40 nearer the object to be irradiated and they are less likely to form a level difference (a recess) between them. Hence, when a wearable device is used as the electronic device 41, a sense of discomfort for such reasons as retention of sweat during wearing of the wearable device is less likely to occur and a loss of light intensity to be measured is less likely to occur. In addition, the solder is out of sight when the wearable device is viewed from the object to be irradiated side and, therefore, the aesthetic quality of the wearable device is less likely to be impaired. Hence, the electronic device 41 can increase the feeling of use and aesthetic quality and can make it less likely that a light intensity loss occurs. As seen from the above, the electronic device 41 can be suitably used, for example, as a wearable device, such as a smartwatch.

Furthermore, in the second embodiment, the prism 31 doubles as a light transmission window member. Therefore, the prism 31 can reduce the number of components in the electronic device 41. In addition, the electronic device 41 can be reduced in size and increased in design flexibility.

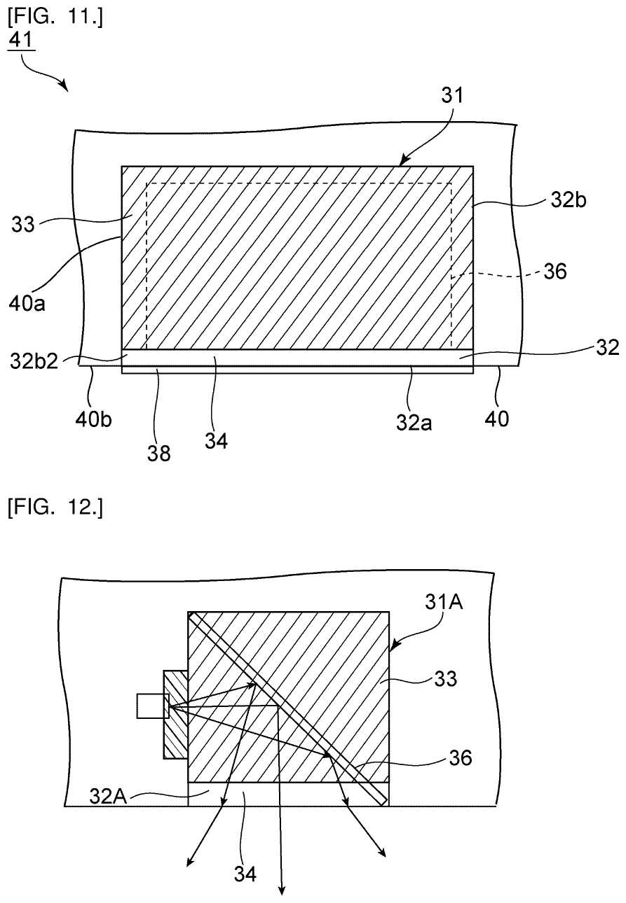

FIG. 12 is a schematic view showing a modification of the prism and the electronic device according to the second embodiment of the present invention. In a prism 31A according to the modification, a substrate 32A is formed by bonding together two substrates having an approximately triangular cross-sectional shape. Like this, the prism 31A may be constituted by the substrate 32A having an approximately rectangular cross-sectional shape. By doing so, the prism 31A can be easily mounted to a housing.

### REFERENCE SIGNS LIST

1, 1A, 1B . . . light transmission window member
2, 32, 32A . . . substrate
2a . . . first principal surface
2b . . . second principal surface
2c, 32b . . . side surface
2d . . . corner portion
3 . . . metalized film
3a . . . adhesion layer
3b anti-diffusion layer
3c . . . solder bonding layer
4, 4A, 34 . . . solder blocking portion
5, 35 . . . light transmission portion
6 . . . solder
7 . . . inorganic film
8, 38 . . . antireflection film
10, 40 . . . housing
10a, 40a . . . opening
10b, 40b . . . surface
11 . . . film-forming jig
12 . . . mask
21, 41 . . . electronic device
22, 42 . . . light source
23, 31, 31A . . . prism
24, 44 . . . refractive index matching resin
32a . . . bottom surface
32b1 . . . light entrance surface
32b2 . . . reflective surface
33 . . . metalized film
36 . . . reflective film

1. A light transmission window member comprising:
a plate-shaped substrate including a light transmission portion; and
a metalized film provided on at least a portion of a side surface of the substrate,
wherein a solder blocking portion is provided on at least a portion of the side surface of the substrate.

2. The light transmission window member according to claim 1, wherein
the substrate includes: a first principal surface provided on a light entrance side of the substrate; a second principal surface opposed to the first principal surface and provided on a light exit side of the substrate, the side surface connects the first principal surface and the second principal surface, and
the metalized film is also provided on the first principal surface.

3. The light transmission window member according to claim 2, wherein the metalized film is also provided on a corner portion connecting the first principal surface and the side surface of the substrate.

4. The light transmission window member according to claim 2, wherein a ratio of a thickness of the metalized film on the side surface to a thickness of the metalized film on the first principal surface ((thickness on side surface)/(thickness on first principal surface)) is not less than 0.05 and not more than 1.00.

5. The light transmission window member according to claim 2, wherein when a direction connecting the first principal surface and the second principal surface is a thickness direction, the solder blocking portion is provided on the side surface of the substrate to extend in the thickness direction from the second principal surface.

6. The light transmission window member according to claim 5, wherein the solder blocking portion is provided on a portion of the side surface constituting not less than 5% and less than 100% of an entire thickness of the side surface and extending in the thickness direction from the second principal surface.

7. The light transmission window member according to claim 1, wherein the solder blocking portion is constituted by a portion which is other than where the metalized film is provided and in which the substrate is exposed.

8. The light transmission window member according to claim 1, wherein the solder blocking portion is constituted by an inorganic film being provided in a surface layer of the light transmission window member.

9. The light transmission window member according to claim 8, wherein the inorganic film is an oxide film, a nitride film, a fluoride film or a sulfide film.

10. The light transmission window member according to claim 1, wherein the metalized film comprises:
an adhesion layer that contacts the substrate and contains at least one of Cr and Ti;
an anti-diffusion layer that is provided on the adhesion layer and contains at least one selected from the group consisting of Ni, Pt, and Pd; and
a solder bonding layer that is provided on the anti-diffusion layer and contains at least one of Au and Pt.

11. The light transmission window member according to claim 1, wherein
solder is provided on the metalized film, and
the solder contains at least one selected from the group consisting of Au, Sn, and In.

12. The light transmission window member according to claim 11, wherein the solder is in a ring preform or in paste form.

13. The light transmission window member according to claim 1, wherein a shape in plan of the substrate is approximately circular or approximately rectangular.

14. A light transmission window member comprising:
a plate-shaped substrate including a light transmission portion; and
a metalized film provided on at least a portion of a side surface of the substrate and having a high wettability for solder,
wherein a solder blocking portion having a low wettability for solder is provided on at least a portion of the side surface of the substrate.

15. A method for manufacturing a light transmission window member, the method comprising the steps of:
preparing a plate-shaped substrate including a light transmission portion; and
depositing a metalized film on at least a portion of a side surface of the substrate,
wherein depositing the metalized film is performed to provide a solder blocking portion on at least a portion of the side surface of the substrate.

16. The method for manufacturing a light transmission window member according to claim 15, wherein the metalized film is deposited by a vacuum evaporation method or a sputtering method to spread from a portion of a principal surface of the substrate located on a light entrance side of the substrate to the portion of the side surface.

17. A method for manufacturing a light transmission window member, the method comprising the steps of:
preparing a plate-shaped substrate including a light transmission portion; and
depositing a metalized film having a high wettability for solder on at least a portion of a side surface of the substrate,
wherein depositing the metalized film is performed to provide a solder blocking portion having a low wettability for solder on at least a portion of the side surface of the substrate.

18. A prism comprising:
a prism-shaped substrate that has a bottom surface and a side surface connected to the bottom surface and includes a light transmission portion; and
a metalized film provided on at least a portion of the side surface of the substrate,
wherein a solder blocking portion is provided on at least a portion of the side surface of the substrate.

19. A prism comprising:
a prism-shaped substrate that has a bottom surface and a side surface connected to the bottom surface and includes a light transmission portion; and
a metalized film provided on at least a portion of the side surface of the substrate and having a high wettability for solder,
wherein a solder blocking portion having a low wettability for solder is provided on at least a portion of the side surface of the substrate.

20. An electronic device comprising:
a housing having an opening; and
the light transmission window member according to claim 1 and fitted in the opening of the housing.

21. The electronic device according to claim 20, wherein a surface of the housing in which the opening is provided is provided in substantially the same plane as a surface of the light transmission window member located on a light exit side.
